(19) United States
(12) Patent Application Publication
(10) Pub. No.: US 2010/0028736 A1
(43) Pub. Date: Feb. 4, 2010

(54) Hybrid Ionomer Electrochemical Devices

(75) Inventors: Murat UNLU, Doraville, GA (US); Paul KOHL, Atlanta, GA (US); Junfeng ZHOU, Atlanta, GA (US)

Correspondence Address: BRYAN W. BOCKHOP, ESQ.;BOCKHOP & ASSOCIATES, LLC, 2375 MOSSY BRANCH DR., SNELLVILLE, GA, 30078, US

(73) Assignee: GEORGIA TECH RESEARCH CORPORATION, Atlanta, GA (US)

(21) Appl. No.: 12/534,117

(22) Filed: Aug. 1, 2009

Related U.S. Application Data
(60) Provisional application No. 61/085,631, filed on Aug. 1, 2008.

(51) Int. Cl. H01M 4/92; C25B 9/06

(52) U.S. Cl. 429/17; 429/27; 204/280

(57) ABSTRACT

A membrane electrode assembly for use in a fuel cell includes an anode electrode, a cation exchange membrane, an anion exchange membrane and a cathode electrode. The anode electrode includes a first catalyst. The first catalyst separates a reducing agent into a plurality of positively charged ions and negative charges. The cation exchange membrane is configured to favor transport of positively charged ions therethrough and is also configured to inhibit transport of negatively charged particles therethrough. The anion exchange membrane is configured to favor transport of negatively charged ions therethrough and is also configured to inhibit transport of positively charged ions therethrough. The cathode electrode includes a second catalyst and is disposed adjacent to a second side of the anion exchange membrane. The second catalyst reacts electrons with the at least one oxidizing agent so as to create reduced species.

### CROSS-REFERENCE TO RELATED APPLICATION(S)

This application claims the benefit of U.S. Provisional Patent Application Ser. No. 61/085,631, filed Aug. 1, 2008, the entirety of which is hereby incorporated herein by reference.

### STATEMENT OF GOVERNMENT INTEREST

This invention was made with support from the U.S. government under grant number CTS-0624620, awarded by the National Science Foundation. The government may have certain rights in the invention.

### BACKGROUND OF THE INVENTION

1. Field of the Invention

The present invention relates to electrochemical devices and, more specifically, to electrochemical devices that employ ion exchange membranes.

2. Description of the Prior Art

Fuel cells have the potential to provide clean and efficient energy sources for stationary, traction, and portable applications. Among the various types of fuel cells, the proton exchange membrane fuel cell (PEMFC) has several desirable features including a high level of development.

Typical PEMFC's employ a proton exchange membrane (such as Nafion®) around which is disposed two electrodes: an anode that includes a catalyst (such as platinum) and a cathode. A fuel, such as hydrogen gas, passes along the anode where the catalyst causes hydrogen atoms to be oxidized (act as a reducing agent) and split into positively-charged ions (e.g., protons in the case where hydrogen is the fuel) and electrons. The positively-charged tend to pass through the proton exchange membrane and the electrons travel through an electrical circuit to the reunite with the positively charged-ions and other reactants, which are reduced (act as an oxidizing agent) on the cathode side of the fuel cell.

Although PEMFC's have been successfully used in numerous applications, several disadvantageous features impede wide-scale commercialization of PEMFC's. For example, PEMFC's exhibit sluggish reaction kinetics, complex water management, carbon monoxide poisoning, limited lifetime due to membrane and electrode degradation and they require expensive noble metal catalysts and perfluorinated membranes. Typical PEMFC's require water to be transported from one side of the fuel cell to the other side to maintain the reaction. If too much water is produced by the fuel cell, the cell becomes flooded; if too little water is produced, the power output can be sub-optimal in low humidity conditions.

In an attempt to reduce fuel cell costs, attempts have been made to develop anion exchange membrane (AEM) fuel cells. Many AEM fuel cells are metal-free, operate at a high pH state and avoid carbonate poisoning (i.e. precipitation of carbonate salts). Such carbonate poising presents a major obstacle in conventional alkaline fuel cells, which use sodium or potassium hydroxide as an electrolyte.

The high pH environment within AEM fuel cells addresses many of the shortfalls with PEM-based fuel cells. Advantages of AEM-based fuel cells (AEMFC's) include the following: (i) the more facile electrokinetics allow for the use of non-noble metals, such as silver and nickel as catalysts; (ii) the wide selection of catalytic metals potentially extends the opportunity for selective catalysis; (iii) the direction of ion migration is from the cathode to the fuel-anode (opposite that of a PEM-based fuel cell) which may lower fuel crossover because electro-osmotic drag is in the opposite direction; (iv) the use of hydrocarbon membranes in place of a perfluorinated membrane may lower the cost of materials; and (v) more facile CO oxidation in an alkaline environment may significantly reduce CO poisoning.

Although AEMFCs offer important potential advantages, they also exhibit a lower ionic conductivity of AEMs compared to Nafion®. This is a concern because it may lower the performance of the fuel cell. Recent efforts have resulted in ionic conductivities of 20 to 30 mS/cm, which are lower than the conductivity of Nafion® (which is about 92 mS/cm).

Therefore, there is a need for an electrochemical device that is self hydrating without requiring complex water management schemes and that does not produce large amounts of undesirable compounds.

### SUMMARY OF THE INVENTION

The disadvantages of the prior art are overcome by the present invention which, in one aspect, is a membrane electrode assembly for use in a fuel cell for converting a reducing agent to electrical energy, that includes an anode electrode, a cation exchange membrane, an anion exchange membrane and a cathode electrode. The anode electrode includes a first catalyst and has a first anode surface and an opposite second anode surface. The anode electrode is configured to receive the reducing agent along the first anode surface. The first catalyst is configured to separate the reducing agent into a plurality of positively charged ions and negative charges. The cation exchange membrane has a first cation exchange membrane side disposed adjacent to the second anode surface of the anode electrode and an opposite second cation exchange membrane side. The cation exchange membrane is configured to favor transport of positively charged ions therethrough and is also configured to inhibit transport of negatively charged particles therethrough. The anion exchange membrane has a first anion exchange membrane side that is disposed adjacent to the second cation exchange membrane side of the cation exchange membrane so as to form a membrane junction therebetween. The anion exchange membrane also has an opposite second anion exchange membrane side. The anion exchange membrane is configured to favor transport of negatively charged ions therethrough and is also configured to inhibit transport of positively charged ions therethrough. The cathode electrode includes a second catalyst and has a first cathode surface and an opposite second cathode surface. The first cathode surface is disposed adjacent to the second anion exchange membrane side of the anion exchange membrane. The cathode electrode is configured to receive at least one oxidizing agent along the second cathode surface. The second catalyst is configured to react electrons with the at least one oxidizing agent so as to create reduced species.

In another aspect, the invention is an electrochemical device that includes an anode electrode, a cation exchange membrane, an anion exchange membrane, a cathode electrode and an electrical device. The anode electrode includes a first catalyst and has a first anode surface and an opposite second anode surface. The anode electrode is configured to receive the reducing agent along the first anode surface. The first catalyst is configured to separate the reducing agent into a plurality of positively charged ions and negative charges. The cation exchange membrane has a first cation exchange membrane side disposed adjacent to the second anode surface of the anode electrode and an opposite second cation exchange membrane side. The cation exchange membrane is configured to favor transport of positively charged ions therethrough and is also configured to inhibit transport of negatively charged particles therethrough. The anion exchange membrane has a first anion exchange membrane side disposed adjacent to the second cation exchange membrane side of the cation exchange membrane so as to form a membrane junction therebetween and has an opposite second anion exchange membrane side. The anion exchange membrane is configured to favor transport of negatively charged ions therethrough and is also configured to inhibit transport of positively charged particles therethrough. The cathode electrode includes a second catalyst. The cathode electrode has a first cathode surface and an opposite second cathode surface. The first cathode surface is disposed adjacent to the second anion exchange membrane side of the anion exchange membrane. The cathode electrode is configured to receive at least one oxidizing agent along the second cathode surface. The second catalyst is configured to react electrons with the at least one oxidizing agent so as to create reduced species. The electrical device is coupled between the anode electrode and the cathode electrode.

In yet another aspect, the invention is a method of generating electrical energy from a reducing agent, in which a reducing agent is introduced to an anode electrode. The anode electrode includes a first catalyst and that is coupled to a first cation exchange membrane side of a cation exchange membrane. The cation exchange membrane has a second cation exchange membrane side disposed oppositely from the first cation exchange membrane side. The anode electrode is configured to separate the reducing agent into a plurality of positively charged ions and negative charges. An oxidizing agent is introduced to a cathode electrode that includes a second catalyst and that is coupled to a second cation exchange membrane side of an anion exchange membrane. The anion exchange membrane includes a first anion exchange membrane side that is disposed oppositely from the second cation exchange membrane side and that is adjacent to the a second cation exchange membrane side of the first cation exchange membrane. The cathode electrode is configured to receive the oxidizing agent along the second cathode surface. The second catalyst is configured to react electrons with the oxidizing agent so as to create reduced species. A load is coupled between the anode electrode and the cathode electrode. The load is configured to provide an electrical path between the anode electrode and the cathode electrode.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a schematic diagram showing an embodiment of an electrochemical device configured to generate electricity.

FIG. 1B is a schematic diagram showing an embodiment of a membrane electrode assembly of the type configured to be employed in the device shown in FIG. 1A.

FIG. 2 is a schematic diagram showing an embodiment of an electrochemical device configured to generate a substance.

FIG. 3 is a graph showing voltage and power density in relation to current density produced by an electrochemical device configured to generate electricity.

FIG. 4 is a schematic diagram showing an embodiment of a membrane electrode assembly having a membrane junction with an uneven surface.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also as used herein, “negative charges,” “negatively charged ions” and “negatively charged particles” include electrons; “positive charges,” “positively charged ions” and “positively charged particles” include protons.

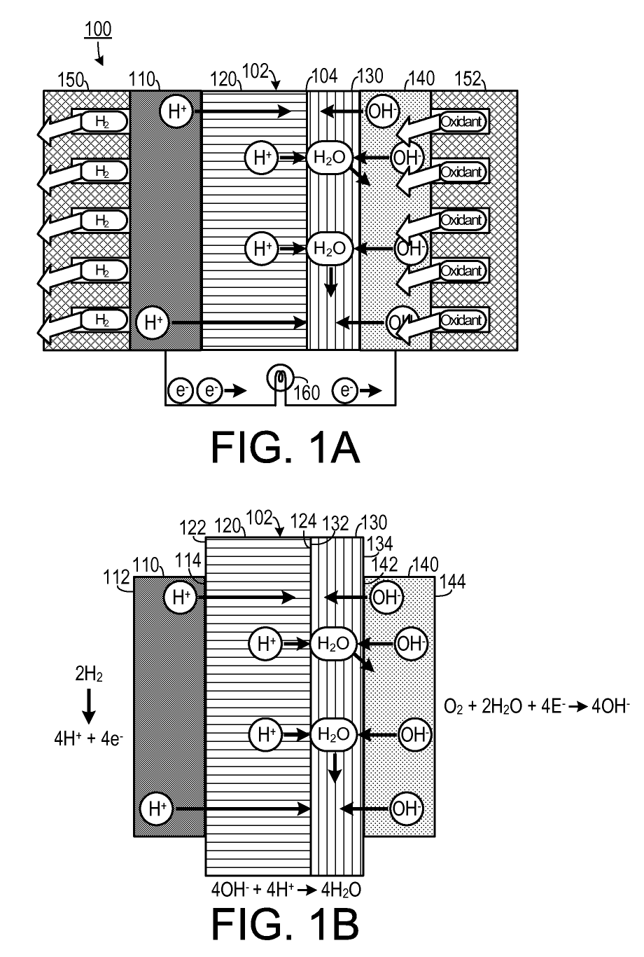

As shown in FIGS. 1A and 1B, one embodiment of an electrochemical device that may be configured to generate electricity, such as a fuel cell 100, includes a hybrid membrane electrode assembly 102 surrounded by a fuel cell hardware assembly. The fuel cell hardware assembly includes a reducing agent flow field casing 150 and an oxidizing agent flow field casing 152. The reducing agent flow field casing 150 is configured to allow a reducing agent (such as hydrogen, as shown, or a hydrocarbon fuel) to pass adjacent to an anode side of the hybrid membrane electrode assembly 102. The oxidizing agent flow field casing 152 is configured to allow an oxidizing agent (such as oxygen, as found in air) to pass adjacent to a cathode side of the hybrid membrane electrode assembly 102. A load 160 may be coupled across the hybrid membrane electrode assembly 102 to draw current from the fuel cell 100.

The hybrid membrane electrode assembly 102 includes an anode electrode 110 having a first anode surface 112, along which passes the reducing agent, and an opposite second anode surface 124. The anode electrode 110 includes a first catalyst includes a material, such as a catalytic metal (e.g., platinum) that is configured to separate the reducing agent (e.g., H₂) into a plurality of positively charged ions (e.g., H⁺ ions) and negative charges (e.g., electrons).

Disposed next to the second anode surface 124 is a cation exchange membrane 120 (which could be made of a material such as Nafion®, available from DuPont). The cation exchange membrane 120 has a first cation exchange membrane side 122 and an opposite second cation exchange membrane side 124. The cation exchange membrane favors transport of positively charged ions (e.g., H⁺) therethrough. However, it also inhibits transport of negatively charged particles (e.g., electrons) therethrough.

While use of hydrogen as a fuel (reducing agent) in the fuel cell 100 is discussed above, other reducing agents can also be used. For example, methanol (CH₃OH) could also be used. In such an embodiment, the anode side would give rise to the following reaction: (2CH₃OH+H₂O→CO₂+6H⁺+6e⁻). The H⁻ ions would pass thorough the cation exchange membrane 120 and the electrons would pass through the load 160. Whereas the cathode side would give rise to the following reaction: (2CO₂+O₂+4e⁻⁻→2CO₃²⁻). The CO₃²⁻ ions would migrate through the anion exchange membrane and react with the H⁻ ions eventually to generate H₂CO₃, which decomposes into CO₂ and H₂O. Thus, a safely-transportable organic fuel could be used to generate electricity while only producing harmless substances.

Disposed next to the second cation exchange membrane side 124 is an anion exchange membrane 130 (such as an ion exchange ionomer, e.g., poly(arylene ether sulfone) functionalized with a plurality of quaternary ammonium groups) that has a first anion exchange membrane side 132 and an opposite second anion exchange membrane side 134. The first anion exchange membrane side 132 is disposed adjacent to the second cation exchange membrane side 124 of the cation exchange membrane 120 and forms a membrane junction 104 therebetween. The anion exchange membrane 130 favors transport of negatively charged ions (e.g., OH⁻) therethrough and also inhibits transport of positively charged ions therethrough.

A cathode electrode 140 is disposed next to the second anion exchange membrane side 134. The cathode electrode 140 includes a second catalyst, which could include catalysts such as: platinum, palladium, silver, nickel and combinations thereof. In one lower cost embodiment, nickel is used as the second catalyst. The cathode electrode 140 has a first cathode surface 142 and an opposite second cathode surface 144. The first cathode surface 142 is disposed adjacent to the second anion exchange membrane side 134 of the anion exchange membrane 130. The cathode electrode 140 receives the oxidizing agent flowing through the oxidizing agent flow field casing 152 along the second cathode surface 144 and reacts electrons received from the anode electrode 110 through the load 160 with the oxidizing agent (and water molecules received through the anion exchange membrane 130 in the case where the reducing agent includes H₂) to create reduced species (such as OH⁻ ions).

As shown in FIG. 3, one embodiment of a fuel cell of the type shown in FIG. 1A, generates a voltage as a function of current density according to curve 310. This embodiment also generates a power density as a function of current density according to curve 312.

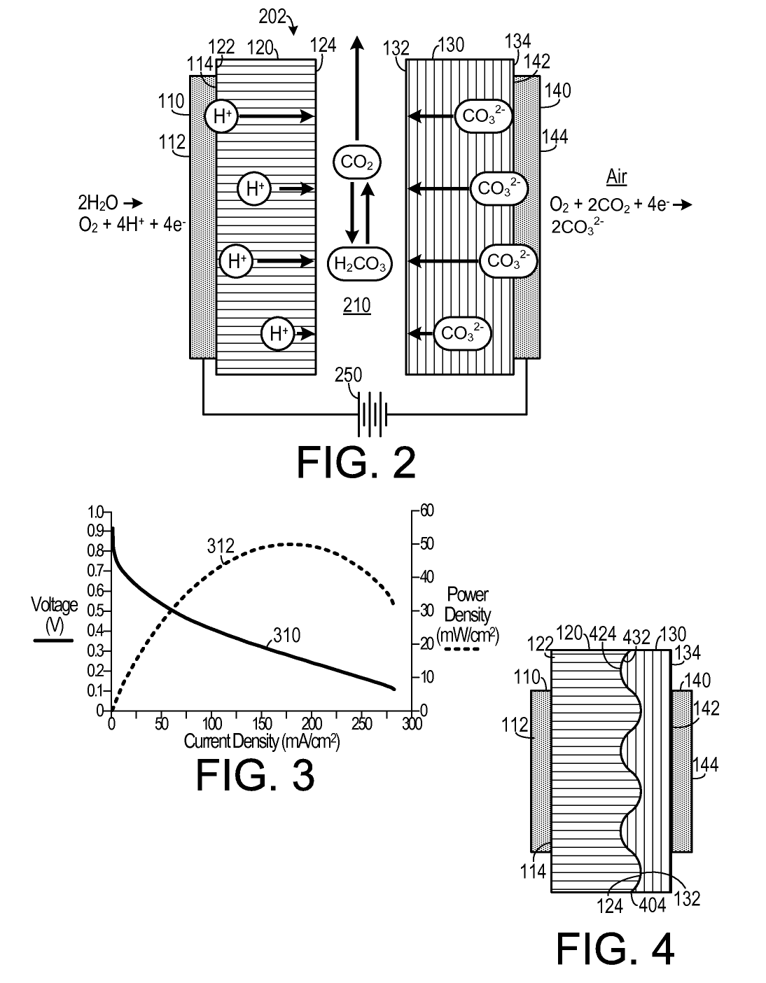

As shown in FIG. 2, in an embodiment configured to generate a target substance (such as concentrated CO₂, a voltage source may be coupled between the anode electrode 110 and the cathode electrode 140. The voltage source could be used to provide electrons to the cathode electrode 140 for use in a reaction designed to generate target ions from substances (such as air) adjacent to the cathode electrode 140. In this embodiment, positive ions (e.g., H⁺) will be generated by the anode electrode 110 and pass through the cation exchange membrane 120 to a channel 210 defined between the cation exchange membrane 120 and the anion exchange membrane 130. Similarly, the target ions (e.g., C0₃²⁻, in the case of a CO₂ scrubbing system) will migrate to the channel 210 through the anion exchange membrane. The positive ions and the target ions will react in the channel 210 for form the desired compound. This embodiment could be useful in applications where it is desirable to remove a substance from, for example, the air. For example, if the air includes oxygen and carbon dioxide, this embodiment could be useful in removing the carbon dioxide from the air. Such an embodiment could be useful for such applications as carbon sequestration and carbon dioxide scrubbing in manned spacecraft and undersea vehicles.

In an embodiment shown in FIG. 4, the second cation exchange membrane side 124 includes at least one first surface irregularity 424 and the first anion exchange membrane side 132 includes at least one second surface irregularity 432 that is complimentary to the first surface irregularity 424. When placed together, these surface irregularities create an irregular junction 404, which provides greater control as to where the positive ions and the negative ions react. Also, control of the thickness of the anion exchange membrane 130 controls the amount of a compound (e.g., water), resulting from the reaction of the positive ions and the negative ions, that will be available to the cathode electron 140 in performing its reactions. In the example of a hydrogen fuel cell, these features can eliminate the need for pumping water from to the cathode side of the cell.

In an experimental embodiment, to exploit the electrochemical advantages of the high pH environment in the electrodes and high conductivity of existing PEM technology (e.g. Nafion), a hybrid fuel cell was used one AEM electrode at high pH, the another electrode composed of existing PEM technology (Nafion), and a high conductivity Nafion membrane separator. The AEM/PEM junction introduces an additional potential, Eⱼ, to the Nernst voltage, according to the following equation:

$${E}_{j} = {φ}^{AEM} - {φ}^{PEM} = \frac{RT}{F} I n ( {a}_{{H}^{+}}^{PEM} {a}_{{OH}^{-}}^{AEM} ) - \frac{RT}{F} I n ( {K}_{w} )$$

For wide differences in pH, the junction potential, Eⱼ, can exceed 0.8 V, such as in the PEM/AEM hybrid with unit activity of H⁺ and OH⁻, respectively. The junction potential at the AEM/PEM boundary balances the changes in the standard potential at the electrodes due to their difference in pH resulting in a thermodynamic cell voltage of 1.23 V. Two configurations were tested: AEM anode with PEM cathode, and PEM anode with AEM cathode. The AEM anode/PEM cathode resulted in water dissociation at the AEM/PEM junction in order to maintain ionic conductivity.

The operation at the PEM-anode/AEM-cathode configuration was successfully demonstrated resulting in water generation at the PEM/AEM junction. The half cell, PEM/AEM interface, and overall reactions are given in the following equations:

$$\begin{matrix}\begin{matrix}Anode ; & {H}_{2} \to 2 {H}^{+} + 2 {e}^{-} & {E}_{An}^{0} = 0.00 V ( SHE )\end{matrix} & ( 1 ) \\ \begin{matrix}Cathode ; & \frac{1}{2} {O}_{2} + {H}_{2} O + 2 {e}^{-} \to 2 {OH}^{-} & {E}_{Cat}^{0} = 0.40 V ( SHE )\end{matrix} & ( 2 ) \\ \begin{matrix}Interface ; & 2 {OH}^{-} + 2 {H}^{+} \to 2 {H}_{2} O\end{matrix} & ( 3 ) \\ \begin{matrix}Overall ; & {H}_{2} + \frac{1}{2} {O}_{2} \to {H}_{2} O & {E}_{Cell} = 1.23 V\end{matrix} & ( 4 )\end{matrix}$$

Although oxygen reduction in a high pH environment occurs at lower potentials (0.4 V) than under acidic conditions, (1.23 V), the voltage loss at the cathode is compensated by the junction potential, Eⱼ=(RT/F)1n(α_{OH}_{^{−}}^{AEM}α_{H}_{⁺}^{PEM}/K_{w}), which constitutes a positive bias to the cell voltage. Not surprising, the thermodynamic cell potential for the full reaction, Eq. 4, is the same regardless of the cell configuration as long as the protons and hydroxide are not consumed during the reaction (i.e. steady state operation) since the overall hydrogen/oxygen reaction is the same in all cases.

Water generation at the AEM/PEM junction produces a self-hydrating effect. Water is produced at the air cathode in a PEM cell or at the fuel anode in an AEM cell. At low humidity, both of these types of cells can experience problems because water has to be transported from the water producing electrode to the second electrode. However, in the PEM/AEM hybrid, as claimed below, water is produced within the membrane allowing for greater retention and easier transport to the second electrode. Preliminary studies here have shown that the performance of hybrid fuel cell without external humidification at 65° C. was superior to the performance of conventional PEM fuel cells.

In an experimental embodiment, a Nafion® solution (5% suspension by mass) was used as the ionomer in the fabrication of a low pH electrode (PEM electrode). The high pH electrode (AEM electrode) was made using an anion exchange ionomer (AEI), poly (arylene ether sulfone) functionalized with quaternary ammonium groups. The AEI was stored in the Cl⁻ form as a solution of 5% mass in dimethyl formamide (DMF). The Nafion® membranes were pretreated with 3% H₂O₂ and 1 M H₂SO₄ solutions. The catalyst was platinum supported on carbon (Pt/C, E-Tek) with Pt loading of 20%.

The catalyst ink for the PEM electrode was prepared by mixing the Nafion® solution, Pt/C catalyst, isopropyl alcohol (IPA), and water. The catalyst ink for the anionic, AEM electrode was prepared by mixing the Pt/C catalyst and the AEI with a mixture of water and DMF (2:3 by mass). The catalyst inks were sonicated for 15 minutes and then cast onto hydrophobic Toray carbon paper (TGPH-090). Resulting electrodes had high (0.5 mg cm⁻²) or low (0.3 mg cm⁻²) ionomer content. After drying at room temperature, 50 μL of AEI in DMF (1% mass) was sprayed directly onto the AEM electrode surface. the AEM electrode was immersed in aqueous 0.1 M KOH to exchange OH⁻ for Cl⁻. The resulting electrodes had a surface area of 2 cm².

Prior to assembling the electrodes onto the membrane, 100 μL of Nafion® (5% suspension):IPA mixture (1:2 by volume) was sprayed onto both the AEM and PEM electrodes. The MEA was assembled in two steps. In the first step, the PEM electrode was pressed onto Nafion® 212 at 2 MPa gauge pressure and 135° C. for 3 min. In the second step, the AEM electrode was pressed onto the PEM half-cell assembly at 2 MPa and ambient temperature for 3 min.

A fuel cell hardware assembly (available from Fuel Cell Technologies, Inc.) was made of a pair of Poco graphite blocks with a single-serpentine flow pattern. All MEAs were preconditioned by operation at a steady state at 600 mV discharge voltage before performing I-V polarization experiments. The scan rate was 1 mV/s for I-V measurements. Electrochemical measurements were performed using a PAR 2273 potentiostat/galvanostat. Fuel cell tests were conducted at ambient pressure. AC impedance spectra were measured, following the steady state discharge at 600 mV, in the constant voltage mode using frequencies from 50 mHz-10 kHz. The amplitude of the AC voltage was 10 mV.

The performance of the hybrid cells was evaluated at different relative humidity levels. The cell voltage for a cell discharged at 100 mA cm⁻² constant current at 60° C. The relative humidity (RH) was increased from 0% to 100% in increments of 25% every 24 hours. At the end of each 24 hour period, current-voltage curves were collected. Two hybrid MEAs with different ionomer loadings in the AEM electrode were tested: 0.3 mg cm⁻² (named MEA-L) and 0.5 mg cm⁻² (MEA-H). For the 0.3 mg cm⁻² ionomer content, MEA-L, the initial cell voltage was 615 mV at 0% RH. The cell voltage increased slightly at the end of 24 hour-period for the 0 and 25% RH experiments. When the relative humidity was higher than 50%, the open circuit decreased slightly after 24 hour of operation. The drop in cell voltage was more severe at higher RH conditions. The cell voltage dropped to 500 mV at the end of 24 hours of operation at 100% RH. The reproducibility of the cell performance was confirmed by lowering the RH to 0% after the fully humidified test. The voltage rapidly increased back to 670 mV.

In-situ AC impedance spectroscopy was used to help understand the change in cell performance with RH. For all conditions, the impedance spectrum was a semicircle loop. The high frequency x-intercept is predominantly the MEA resistance established by the ionic resistance of the membrane. These spectra showed that the ionic resistance of the membrane was nearly constant from 0% to 100% RH. However, the radius of the semicircle loop increased with RH. Typically, the difference between the x-intercept values of the semi-circular response at high and low frequency is mainly governed by interfacial oxygen reduction kinetics, ionic conductivity and diffusion limitations within the depletion layer. Since the decrease in ionic conductivity of the PEM at high RH is not expected, the diffusion limitation within the catalyst layer was a likely reason of the increased resistance at higher RH values. These results demonstrate that the water generated at the interface of the AEM and PEM maintains adequate hydration in the MEA when the inlet gases were dry. Hydration of the gas streams results in excess water within the membrane and flooding of the electrodes and limited oxygen diffusion in the cathode catalyst layer. This is a significant result because the performance of conventional polymer electrolyte fuel cell relies on fully humidified gas feeds. Hydration or wicking of water from one electrode to the other can cause added complexity and loss in efficiency.

Higher ionomer loadings, 0.5 mg cm⁻² (MEA-H), were investigated as a function of RH to understand the effect of ionomer loading on performance of the AEM electrode. The initial cell voltage was 504 mV at 0% RH and increased with time due to hydration of the MEA from the water produced at the AEM/PEM interface. When the relative humidity was increased to 25%, the MEA-H cell voltage gradually decreased. The decrease in cell potential became steeper when the RH was increased to 50%. Operation of the MEA-H cell failed at 75% RH. The higher ionomer loading resulted in poorer performance than the low ionomer electrode. This difference between the two MEAs is more pronounced at high RH. The response can be better understood by examining the I-V behaviour of the cells at different RH.

At 0% RH and 60° C., the MEA-H showed better performance than MEA-L at low current density (<120 mA cm⁻²). However, the performance of MEA-H may rapidly degrade at high current. Typically, voltage polarization at high current density is a sign of mass transfer limitations. The mass transfer resistance is also seen in the AC impedance spectra for MEA-H. Regarding AC impedance data at cell voltages from 400 mV to 850 mV, at the lowest current (highest cell voltage), 850 mV, the charge transfer resistance dominates, i.e. the largest loop. When the cell voltage decreases to 800 and 700 mV, the charge transfer resistance is lower. Decreasing the voltage below 700 mV results in a increase in the size of the semicircle. This observation shows that the diffusion limitation still occurs in the electrode layer when the gas feeds are dry. Moreover, the shape of the semicircle at low frequency was distorted when the cell voltage was 400 mV, which is generally an indication of mass transfer limitations in the gas diffusion layer. Since both oxygen and water are consumed (1:2 stoichiometry) in the cathode reaction, either could be the limiting reagent and the reason for the increase in mass transfer resistance. The diffusion of water from the PEM/AEM interface to the catalyst sites are not expected to be the limiting factor at higher current density because water is produced at the PEM/AEM interface at twice the rate that it is consumed at the AEM cathode. Thus, oxygen diffusion is believed to be primary reason for the mass transport limitations mentioned above. There are two possible causes for the increased mass transport resistance at high ionomer content in the cathode; physical barrier to gas transport by the ionomer itself or increased water content.

An additional comparison was made between the high and low ionomer loadings in the catalyst layer by observing the change in the internal resistance of MEAs during dry operation at 60° C. The high frequency x-intercept, R_{HF}, of AC the impedance spectra for the different voltages and for the high ionomer loading, MEA-H, was 212(±3) Ωcm² at 800 mV and decreased at higher currents (lower cell voltages) reaching 174 Ωcm² at 200 MV. R_{HF} for the low ionomer content, MEA-L, was 629(±96) Ωcm² at 800 mV and decrease to 175 Ωcm² at 200 mV. At low current density (high cell voltage), the water generated at the interface was not sufficient to fully hydrate the MEA, resulting in higher electrolyte resistance. The MEA-L electrode was more sensitive to hydration since it has a lower ionomer content (i.e. dehydrated faster at low humidity conditions). In contrast, the high ionomer content electrode retains water and more easily achieves full hydration. The hydration level quickly recovered at high current density for both electrodes following dehydration. These observations are consistent with the lower performance of MEA-L than MEA-H at low current densities. The water production is greater at higher current densities resulting a flooding in the catalyst layer. The performance of MEA-L is better than MEA-H due to faster dehydration of water from the electrodes, decreasing the flooding.

The flow rate of the inlet gases plays an important role in the fuel cell performance, particularly in dry operations. The effect of flow rate on the performance of hybrid MEA-L operating at 600 mV was studied at 0% RH. The steady-state current density obtained for different flow rates at 60° C. indicates that the performance of cells increases at higher anode and cathode flow rates. When the gas flow rates are 1 sccm O₂ and 2 sccm H₂, the current density is 39 mA cm⁻² at 600 mV, corresponding a stoichiometric ratio (the ratio of the gas flow supplied in the gas feeds to the gas consumed at the reaction at a given current density) of 4 for both gas streams. At high flow rates, 8 sccm H₂ and 8 sccm O₂, the current density was 143 mA cm⁻² at 600 mV. The stoichiometric ratios are 8 for H₂ and 4 for O₂. Typically, it is undesirable to operate an MEA at dry conditions with high stoichiometric flow rates because the rapid evaporation of the water at the cathode will lead to dry-out of the MEA. However the trend is opposite for the hybrid cells disclosed above.

In more detailed analysis, the effect of flow rate on the performance was analyzed by in situ AC impedance spectroscopy. The cell temperature was 60° C., the RH was 0%, and the oxygen flow rate at the anode was kept constant at 4 sccm. The impedance spectra of hybrid MEA operating at 600 mV for cathode flow rates of 2, 4, 6, and 8 sccm indicate that the high frequency x-intercepts (i.e. electrolyte resistance) are similar. These resistances are identical to the electrolyte resistance of MEAs operated at highly humidified conditions, showing the fully hydrated state of MEA at the flow rates used here. There is a significant drop in the low frequency x-intercept corresponding to a drop in the charge transfer resistance as the flow rate increases. This change in charge transfer resistance is attributed to the increased mass transport of oxygen into the electrode layer at high flow rates. The generation of water within the membrane close to the cathode can lower the access of the oxygen to the catalyst sites. Higher feed flow rates at the cathode increases the rate of water evaporation and increases the oxygen access to the catalyst sites. To confirm this effect on flow rate, an additional test was performed. Dry nitrogen gas was added to cathode stream increasing the total flow rate. This results in a higher rate of evaporation and dilution of the oxygen partial pressure in the cathode feed. The anode flow rate was held constant at 6 sccm for all experiments. The cell was initially run with the oxygen flow rate of 4 sccm at the current density of 100 mA cm⁻². The cell voltage was 510 mV. An additional flow for 2 sccm nitrogen was added to the cathode feed at constant feed pressure and the oxygen flow rate was kept at 4 sccm. After a short period of time, the cell voltage increased to above 600 mV. When the flow rate of nitrogen was increased to 4 sccm, the cell voltage was 590 mV which was significantly higher than the pure oxygen at flow rate of 4 sccm, even though the partial pressure of oxygen dropped by 50%. This test clearly shows that the improved performance at higher flow rates is prominently due to faster water removal from the cathode electrode at higher gas feed rates, enhancing oxygen access to the catalyst sites through more rapid water evaporation.

The effect of anode feed on cell performance was also evaluated. AC impedance spectra were collected for different anode flow rates while the cathode flow rate remained was constant at 4 sccm dry oxygen. The low frequency x-intercept decreased, reflecting a decrease in the charge transfer resistance, when the anode feed rate of the anode stream increased from 4 to 8 sccm. This is a significant increase in the performance with the anode flow rate. Since the anode is a traditional PEM electrode, hydrogen diffusion limitations are not expected at the moderate current densities obtained here. Also, the hybrid cell generates water close to the cathode so that anode flooding is not likely to occur. This effect of the anode flow rate on cell current is attributed to lowering the flooding in the cathode electrode. Higher evaporation rate for water at anode lowers the amount of water diffusing to the cathode from PEM/AEM interface, which subsequently decreases the water diffusion to the cathode.

An additional observation was made from the anode flow rate experiments. The high-frequency x-intercept in the AC impedance spectra, corresponding to electrolyte resistance, increased when the anode flow rate was increased from 4 sccm to 8 sccm. This indicates an increase in electrolyte resistance due to membrane dry-out. This behaviour corroborates that dehydration at high flow rates causes enhanced dehydration at the anode. However, this has little effect on the performance because the lower oxygen transfer resistance at the cathode is more significant than the loss of electrolyte conductivity due to dry-out at the anode.

The data presented above consistently shows that the cell performance at 60° C. and 0% relative humidity is prominently limited by flooding within the cathode layer. In order to reduce the flooding in the electrode layer, the hybrid cell was operated at 75° C. and 80° C. without external humidification. Under a cell voltage at 200 mA cm⁻² constant current and feed rates of 8 sccm H₂ at the anode and 6 sccm O₂ at the cathode, at 75° C., the voltage reached to 500 mV after a short induction time. After 7 days of constant current operation, the voltage gradually decreased to 480 mV. When the temperature was increased to 80° C., the cell voltage increased to 580 mV and steady-state performance was achieved. An increase in the oxygen cathode flow rate resulted in an increase in the cell voltage. This preliminary evaluation indicates that the dry-feed performance hybrid fuel cells at 80° C. maintains a sufficient hydration level. The optimum balance between the rate of water removal (operating temperature and flow rates) and water generation (the current density) at the AEM/PEM interface is the key parameter for further improvements in the self-humidifying hybrid fuel cells.

The self humidifying feature of the PEM anode/AEM cathode hybrid cell was evaluated at several test conditions. As opposed to conventional polymer electrolyte fuel cells, the performance of hybrid fuel cell was shown to improve at low relative humidity. I-V and AC impedance spectroscopy results show that the cell performance without external humidification is limited by flooding in the cathode electrode layer. The ionomer fraction within the cathode electrode plays a significant role in the cell performance. The dehydration rate of the electrode layer is lower at higher ionomer loading, increasing the flooding in the cathode layer. The effect of anode and cathode flow rate on the performance with dry gas feeds was significant. High flow rates resulted in faster water removal from the electrode lessening the flooding. Steady state operation at 580 mV and 200 mA cm⁻² was demonstrated using dry H₂/O₂ feeds at 80° C.

Fuel cell construction and reactions are discussed in detail in U.S. patent application No. 11/502,731, filed on Aug. 11, 2006 and published as US Publication No. US 2007-0259236 A1 on Nov. 8, 2007, which is hereby incorporated by reference in its entirety.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A membrane electrode assembly for use in a fuel cell for converting a reducing agent to electrical energy, comprising:
a. an anode electrode including a first catalyst, the anode electrode having a first anode surface and an opposite second anode surface, the anode electrode configured to receive the reducing agent along the first anode surface, the first catalyst configured to separate the reducing agent into a plurality of positively charged ions and negative charges;
b. a cation exchange membrane having a first cation exchange membrane side disposed adjacent to the second anode surface of the anode electrode and an opposite second cation exchange membrane side, the cation exchange membrane configured to favor transport of positively charged ions therethrough and also configured to inhibit transport of negatively charged particles therethrough;
c. an anion exchange membrane having a first anion exchange membrane side, disposed adjacent to the second cation exchange membrane side of the cation exchange membrane so as to form a membrane junction therebetween, and an opposite second anion exchange membrane side, the anion exchange membrane configured to favor transport of negatively charged ions therethrough and configured to inhibit transport of positively charged ions therethrough; and
d. a cathode electrode including a second catalyst, the cathode electrode having a first cathode surface and an opposite second cathode surface, the first cathode surface disposed adjacent to the second anion exchange membrane side of the anion exchange membrane, the cathode electrode configured to receive at least one oxidizing agent along the second cathode surface, the second catalyst configured to react electrons with the at least one oxidizing agent so as to create reduced species.

2. The membrane electrode assembly of claim 1, wherein the first catalyst comprises a catalytic metal.

3. The membrane electrode assembly of claim 1, wherein the second catalyst comprises a metal selected from a group consisting of: platinum, palladium, silver, nickel and combinations thereof.

4. The membrane electrode assembly of claim 1, wherein the cation exchange membrane comprises Nafion®.

5. The membrane electrode assembly of claim 4, wherein the anion exchange membrane comprises an anion exchange ionomer.

6. The membrane electrode assembly of claim 1, wherein the ionomer comprises poly(arylene ether sulfone) functionalized with a plurality of quaternary ammonium groups.

7. The membrane electrode assembly of claim 1, further comprising an electrical load coupled to the anode electrode and to the cathode electrode, the load configured to provide an electrical path between the anode electrode and the cathode electrode.

8. The membrane electrode assembly of claim 1, further comprising a voltage source coupled to the anode electrode and to the cathode electrode, the voltage source configured to transfer electrons to the cathode electrode and to receive electrons from the anode electrode.

9. The membrane electrode assembly of claim 1, wherein the second cation exchange membrane side includes at least one first surface irregularity and wherein the first anion exchange membrane side includes at least one second surface irregularity that is complimentary to the at least one first surface irregularity.

10. An electrochemical device, comprising:
a. an anode electrode including a first catalyst, the anode electrode having a first anode surface and an opposite second anode surface, the anode electrode configured to receive the reducing agent along the first anode surface, the first catalyst configured to separate the reducing agent into a plurality of positively charged ions and negative charges;
b. a cation exchange membrane having a first cation exchange membrane side disposed adjacent to the second anode surface of the anode electrode and an opposite second cation exchange membrane side, the cation exchange membrane configured to favor transport of positively charged ions therethrough and also configured to inhibit transport of negatively charged particles therethrough;
c. an anion exchange membrane having a first anion exchange membrane side, disposed adjacent to the second cation exchange membrane side of the cation exchange membrane so as to form a membrane junction therebetween, and an opposite second anion exchange membrane side, the anion exchange membrane configured to favor transport of negatively charged ions therethrough and also configured to inhibit transport of positively charged particles therethrough;
d. a cathode electrode including a second catalyst, the cathode electrode having a first cathode surface and an opposite second cathode surface, the first cathode surface disposed adjacent to the second anion exchange membrane side of the anion exchange membrane, the cathode electrode configured to receive at least one oxidizing agent along the second cathode surface, the second catalyst configured to react electrons with the at least one oxidizing agent so as to create reduced species; and
e. an electrical device coupled between the anode electrode and the cathode electrode.

11. The electrochemical device of claim 10, wherein the first catalyst comprises a catalytic metal.

12. The electrochemical device of claim 10, wherein the first catalyst comprises a metal selected from a group consisting of: platinum, silver, nickel and combinations thereof.

13. The electrochemical device of claim 10, wherein the cation exchange membrane comprises Nafion®.

14. The electrochemical device of claim 13, wherein the anion exchange membrane comprises an anion exchange ionomer.

15. The electrochemical device of claim 10, wherein the ionomer comprises poly(arylene ether sulfone) functionalized with a plurality of quaternary ammonium groups.

16. The electrochemical device of claim 10, wherein the second cation exchange membrane side includes at least one first surface irregularity and wherein the first anion exchange membrane side includes at least one second surface irregularity that is complimentary to the at least one first surface irregularity.

17. The electrochemical device of claim 10, wherein the electrical device comprises an electrical load coupled to the anode electrode and to the cathode electrode, the load configured to provide an electrical path between the anode electrode and the cathode electrode.

18. The electrochemical device of claim 10, wherein the electrical device comprises a voltage source coupled to the anode electrode and to the cathode electrode, the voltage source configured to transfer electrons to the cathode electrode and to receive electrons from the anode electrode.

19. A method of generating electrical energy from a reducing agent, comprising the actions of:
a. introducing the reducing agent to an anode electrode that includes a first catalyst and that is coupled to a first cation exchange membrane side of a cation exchange membrane, the cation exchange membrane having a second cation exchange membrane side disposed oppositely from the first cation exchange membrane side, wherein the anode electrode is configured to separate the reducing agent into a plurality of positively charged ions and negative charges;
b. introducing an oxidizing agent to a cathode electrode that includes a second catalyst and that is coupled to a second cation exchange membrane side of an anion exchange membrane, the anion exchange membrane including a first anion exchange membrane side that is disposed oppositely from the second cation exchange membrane side and adjacent to the a second cation exchange membrane side of the first cation exchange membrane, wherein the cathode electrode is configured to receive the oxidizing agent along the second cathode surface, the second catalyst configured to react electrons with the oxidizing agent so as to create reduced species; and
c. coupling a load between the anode electrode and the cathode electrode, the load configured to provide an electrical path between the anode electrode and the cathode electrode.

20. The method of claim 19, wherein the first catalyst comprises a noble metal an wherein the second catalyst comprises a metal selected from a group consisting of: platinum, silver, nickel and combinations thereof.

21. The method of claim 19, wherein the cation exchange membrane comprises Nafion®.

22. The method of claim 19, wherein the anion exchange membrane comprises an anion exchange ionomer.

23. The method of claim 19, wherein the ionomer comprises poly(arylene ether sulfone) functionalized with a plurality of quaternary ammonium groups.
